(19) United States
(12) Patent Application Publication
(10) Pub. No.: US 2005/0147092 A1
(43) Pub. Date: Jul. 7, 2005

(54) Data signal transmission control apparatus

(75) Inventors: Masatsugu Kawamoto, Yokohama (JP); Makoto Uchiba, Kawasaki (JP); Kenji Yamada, Yokohama (JP); Naoki Fukuda, Yokohama (JP); Yuji Higashihara, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/072,432

(22) Filed: Mar. 7, 2005

Related U.S. Application Data
(63) Continuation of application No. PCT/JP03/02667, filed on Mar. 6, 2003.

(51) Int. Cl. H04L 12/66

(52) U.S. Cl. 370/357

(57) ABSTRACT

A data signal transmission control apparatus includes a connection unit for connecting a plurality of first lines and any one of at least one second line that are accommodated in a switching unit between the first lines and the second lines for transmitting a speech signal; a control unit for controlling the connection operation of the connection unit; and an isolation/insertion unit for isolating a data signal, flowing on one of the first and second lines connected by the connection unit, from the one line and inserting the data signal isolated from the one line onto the other line.

### BACKGROUND OF THE INVENTION

1. Field of the Invention

The present invention relates to a data signal transmission control apparatus, and relates to a technique applicable to a service that provides access to the Internet by using a telephone extension line system which uses an existing PBX (Private Branch exchange) for example, in hotels and middle and small offices.

2. Description of the Related Art

In a conventional telephone extension line system, as shown in FIG. 11, a PBX (a) accommodates m extension lines (internal lines) and n external lines (outside lines: station lines) in a subscriber (extension line) interface and a station line interface, respectively, and carries out a connection control between the extension line and the external line, and an extension line telephone in each room can be connected to the outside to make a call.

Let us consider the case where the existing PBX (a) as shown in FIG. 11 is used to allow the access to the Internet.

In this case, firstly, a method of dividing a speech signal and a data signal can be considered. For example, as shown in FIG. 12, a configuration in which a splitter (b) and an ADSL (Asymmetric Digital Subscriber Line) modem (c) are connected to each external line, and an Internet device is connected to the ADSL modem (c) can be considered. Also, as shown in FIG. 13, a configuration in which the splitter (b), the ADSL modem (c), and a router (d) are connected to the external line, and the Internet device placed in each room is connected to the router (d) can be considered.

Secondly, as shown in FIG. 14, it can be considered another possible configuration in which an exchange (e) having an existing PBX function, a function for dividing a speech signal and a data signal, and a data line interface is newly developed, the ADSL modem (c) and the router (d) are connected to a data line interface of the exchange (e), the Internet device in each room is connected to the router (d), and the router (d) distributes the data signal from the Internet to the Internet device placed for each room.

Also, as a prior art related to the present invention, there is an invention which relates to an asymmetrical data transmission apparatus that uses asymmetrical digital subscriber lines in which a high speed data network is connected to telephone subscriber lines depending on a request of a subscriber, in which the asymmetrical data transmission apparatus is characterized by including: a plurality of subscriber line connection units which are connected one by one to the respective subscriber lines, isolate an analog signal to be transmitted to the high speed network from the subscriber line, and sense a start signal requesting the connection to the high speed data network from a slave apparatus connected to the subscriber line; a plurality of subscriber modem units, which are connected one by one to respective digital lines of the high speed data network, modulate the digital signal to be transmitted to the slave apparatus from the high speed data network into an analog signal when connected through the subscriber line connection units to the slave apparatus, and demodulate the analog signal to be transmitted to the data network from the slave apparatus into the digital signal; a subscriber line switching units which are linked between the subscriber line connection units and the subscriber modem units, and selectively connect the subscriber line connection units and the subscriber modem units; and a line connection control unit which activates any one of subscriber modems at waiting states in the subscriber modem units when the start signal is sensed by the subscriber line connection unit, and connects the activated subscriber modem through the subscriber line switching unit to the subscriber line connection unit whose start signal is sensed (refer to Patent Document 1).

[Patent Document 1] JP 3007071 B (claim 1, FIG. 1, FIG. 2, FIG. 3)

However, the systems (methods) shown in FIGS. 12 to 14 had the following problems. Here, there are possible cases where the systems (methods) shown in FIGS. 12 to 14 are applied to a hotel.

In the system shown in FIG. 12, the upper limit of the number of the Internet devices that can be connected to the Internet is equal to the number of the station lines. For this reason, when the number of the rooms scheduled to provide connection environments to the Internet exceeds the number of the station lines, some rooms cannot be provided with the connection environment to the Internet. Thus, “service where Internet can be used (hereafter, referred to “service (1)”)” cannot be provided in every room. Also, in the method shown in FIG. 12, a wiring work must be newly performed for each room from each station line.

Also, the system shown in FIG. 13 can be configured such that the service (1) is provided in any room of the hotel. However, in addition to the wiring work from the station line, the establishment and wiring of LAN (Local Area Network) must be carried out inside the hotel. Moreover, the facility of a high cost such as a router requires to be introduced, thereby making the cost higher.

Moreover, in the systems shown in FIGS. 12 and 13, the usage of the Internet (the transmission of the data signal) is not use the PBX. For this reason, the hotel side cannot grasp how long a user used the Internet, so an accurate usage fee for the Internet access (a fee for the service (1)) cannot be collected.

On the other hand, in the system shown in FIG. 14, the wiring is laid in each room through the ADSL modem (c) and the router (d) from the exchange (e). For this reason, without any execution of the wiring work from the station line side, the service (1) can be provided in all of the rooms in the hotel. However, the wiring work from the router (d) to each room is required. Also, there are problems in that the new development of the exchange (e) to be replaced with the existing router (d) is required, and replacing the PBX (a) with the exchange (e) involves additional cost.

### SUMMARY OF THE INVENTION

An object of the present invention is to provide a technique that can prepare the necessary number of the connection environments to the data communication network such as the Internet while utilizing the existing telephone extension line system.

Also, another object of the present invention is to provide a technique that can suppress a cost required to prepare the necessary number of the connection environments to the data communication network while utilizing the existing telephone extension line system.

A data signal transmission control apparatus according to the present invention includes:
a connection unit for connecting any one of a plurality of first lines and any one of at least one second line which are accommodated in a switching unit between the first lines and the second lines for transmitting a speech signal;
a control unit for controlling the connection operation of the connection unit; and
an isolation/insertion unit for isolating a data signal, flowing on one of the first and second lines connected by the connection unit from the one line, and inserting the data signal isolated from the one line onto the other line.

In the present invention, the first line is, for example, an extension line connected to an extension line telephone in the telephone extension line system, and the second line is, for example, an external line (station line) connected to a telephone station in the telephone extension line system. To the switching unit, for example, the PBX and manual selector switch which constitute the telephone extension line system can be applied. The data signal flowing on the first line and second line is, for example, a data signal which is outputted from the Internet device having the connection function to the Internet and modulated to be inserted into the first line, or a data signal from the Internet which is modulated to be inserted into the second line. Also, the transmission control apparatus according to the present invention is installed in the state where the transmission control apparatus is inserted onto the first line and second line which are accommodated in the switching unit.

According to the present invention, the connection unit connects any of first lines and second lines under the control of the control unit, the data signal flowing through the first line is transferred to the second line by an isolation/insertion unit, and the data signal flowing through the second line is transferred to the first line by the isolation/insertion unit. In this way, according to the present invention, transmission paths of the data signals using the first line and second line can be formed, and the Internet device is connected to the Internet by using the transmission paths, thereby transmitting and receiving the data between both of them.

The control unit of the present invention is preferably configured so as to receive, from a speech terminal connected to a certain first line, a request signal for connecting this certain first line and a second line, and control the connection unit so that the certain first line and the second line are connected in accordance with the request signal. With this configuration, the speech terminal placed at a remote location from the transmission control apparatus can be used to connect the first line and the second line.

Also, the control unit of the present invention is preferably configured so as to output a guidance signal, which includes guidance for connecting the certain first line and the second line, from the speech terminal to the speech terminal. With this configuration, the user of the speech terminal can connect the first line and the second line in accordance with the guidance.

Also, the control unit of the present invention is preferably configured such that if the connection unit cannot connect the certain first line and the second line in accordance with the request signal from the speech terminal, it receives from the speech terminal a request signal indicative of waiting for the connection unit to become usable for being capable of connecting the certain first line and the second line. After that, if the connection unit becomes usable, the connection unit notifies the speech terminal of the usable state thereof. With this configuration, the user desiring the operation of the transmission control apparatus can be notified, by using the speech terminal, that the connection between the desired first line and the second line has become possible.

Also, the present invention is preferably configured such that the request signal is given to the control unit of the transmission control apparatus through a connection path that is formed between the transmission control apparatus and the speech terminal through the switching unit and includes the certain first line. With this configuration, for example, the speech terminal and the transmission control apparatus can be linked through the connection path by using the existing telephone extension line system (PBX), which accordingly enables the easy establishment of the communication facility between the speech terminal and the transmission control apparatus.

Also, the control unit of the present invention is preferably configured to control the connection unit so that this certain first line and the second line are connected or disconnected, in accordance with a connection or disconnection instruction between the certain first line and the second line which is manually inputted from an operation unit.

Also, the control unit of the present invention is preferably configured to monitor a communication time, resulting from the connection between the first line and the second line which is connected by the connection unit, to change based on the communication time. With this configuration, a charging can be performed based on the data communication using the data transmission path which results from the connection between any first line and second line.

Also, the control unit of the present invention can be configured to control the connection unit to disconnect the connection between the first line and the second line when the connection time between the first line and the second line reaches a predetermined communicable time. With this configuration, if the charging is performed based on the usage of the data transmission path using the first line and the second line, the user can use the data transmission path within a range of a communicable time preset by the user. This can suppress the charging of an unexpected fee due to communications carried out by the user to a larger extent than they were planed.

Also, the control unit of the present invention is preferably configured to send to the speech terminal a signal including guidance related to the connection between the certain first line and the second line, through the connection path between the transmission control apparatus and the speech terminal accommodating the certain first line via the switching unit generated by a call of the speech terminal connected to the certain first line, and also configured to receive the request signal related to the connection between the certain first line and the second line which is outputted from the speech terminal through the connection path in response to the guidance.

### BRIEF DESCRIPTION OF THE DRAWINGS

FIG. 1 is a view showing a telephone extension line system to which a data signal transmission control apparatus according to the present invention is applied;

FIG. 2A is a view showing a configuration example of the transmission control apparatus of the data signal according to the present invention;

FIG. 2B is an enlarged view of a contact unit of a selector switch shown in FIG. 2A;

FIG. 3 is an explanatory view of an embodiment of the present invention;

FIG. 4 is a flowchart showing an operation of the transmission control apparatus in a case where the transmission control apparatus is operated from the extension line telephone for using the Internet (an operation in a case of a connection to the Internet);

FIG. 5 is a flowchart showing an operation of the transmission control apparatus in a case where the transmission control apparatus is operated from the extension line telephone for using the Internet (an operation waiting for a contact);

FIGS. 6A and 6B are flowcharts showing an operation of the transmission control apparatus in a case where the transmission control apparatus is operated from the extension line telephone for using the Internet (an operation when the usage of the Internet is ended);

FIG. 7 is a flowchart showing an operation of the transmission control apparatus in a case where the transmission control apparatus is operated from an operation panel for using the Internet (the case of the connection to the Internet);

FIGS. 8A and 8B are explanatory views of a modification in the embodiment;

FIGS. 9A, 9B and 9C are explanatory views of a modification in the operation panel;

FIG. 10 is an explanatory view of a modification in the operation panel;

FIG. 11 is a view showing a configuration example of a telephone extension line system using a conventional PBX;

FIG. 12 is an explanatory view of a prior art;

FIG. 13 is an explanatory view of a prior art; and

FIG. 14 is an explanatory view of a prior art.

### DESCRIPTION OF THE PREFERRED EMBODIMENT

The embodiment of the present invention will be described below. The following embodiment is the exemplification, and the present invention is not limited to the configuration of the embodiment.

[Outline of the Invention]

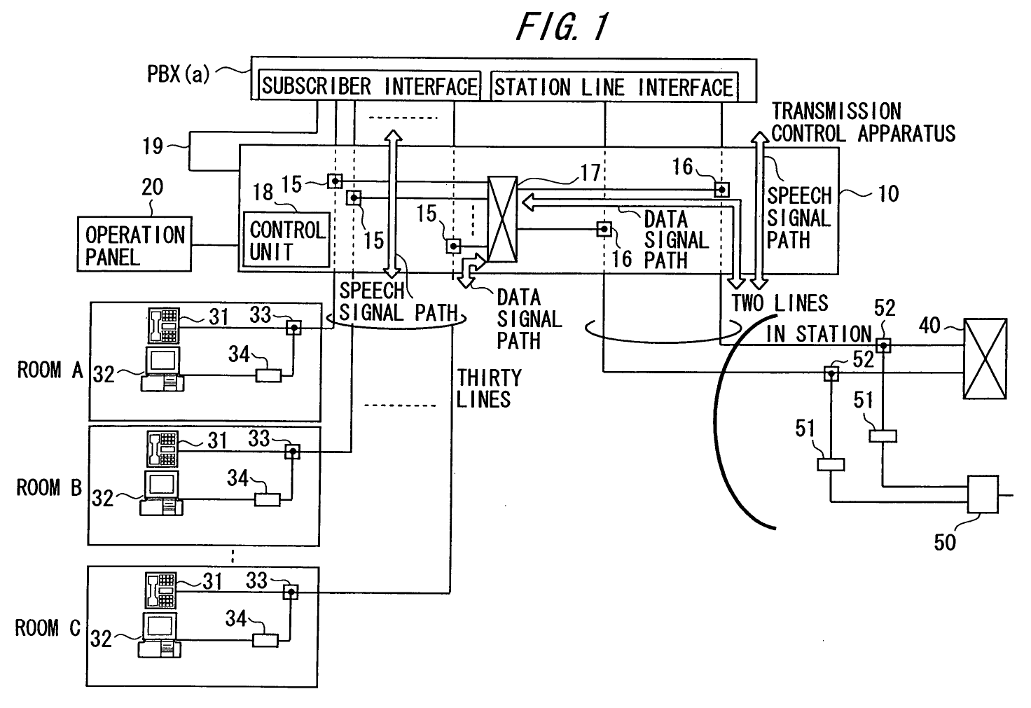

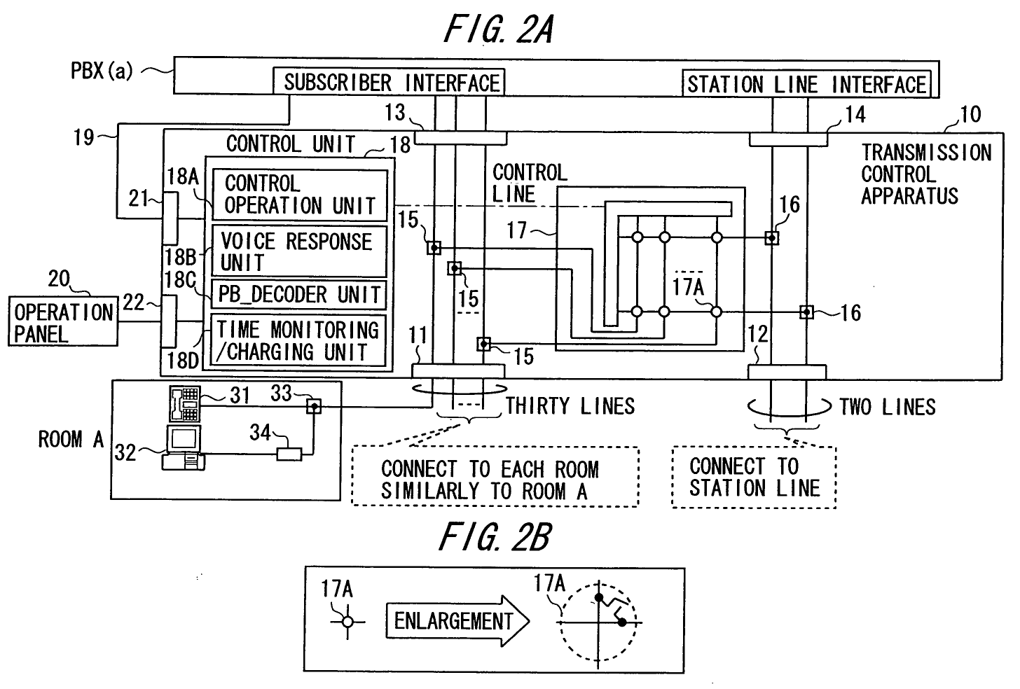

At first, the outline of the present invention is explained. FIG. 1 is a view showing a telephone extension line system to which a data signal transmission control apparatus according to the present invention is applied, FIG. 2A is a view showing a configuration example of the transmission control apparatus of the data signal according to the present invention, and FIG. 2B is an enlarged view of a contact unit of a selector switch shown in FIG. 2A.

FIG. 1 shows an example in which a transmission control apparatus 10 of a data signal according to the present invention is applied to a telephone extension line system having a PBX(a) accommodating a plurality of extension lines (for example, 30 lines) and one or more external lines (station lines: for example, 2 lines).

The transmission control apparatus 10 has: an extension line interface 11 for accommodating the respective extension lines; a station line interface 12 for accommodating the respective station lines; a PBX (extension line) interface 13 for accommodating a speech signal line corresponding to each extension line to be connected to a subscriber (extension line) of the PBX (a); and a PBX (station line) interface 14 for accommodating the speech signal line corresponding to each station line to be connected to the station line interface of the PBX (a) (refer to FIG. 2A).

The station line interface 12 accommodates each of the station lines (two lines) connected to an exchange (e.g., exchange 40 as shown in FIG. 1) inside a telephone station, and the station line interface 12 and the PBX (station line) interface 14 are connected through a signal transmission path (indicated by a dashed line in FIG. 1) corresponding to each station line laid inside the transmission control apparatus 10.

The extension line interface 11 accommodates each extension line connected to an extension line telephone 31 (also, referred to as [Telephone 31]) respectively placed at each predetermined location (for example, a room of a hotel). The extension line interface 11 and the PBX (extension line) interface 13 are connected through the signal transmission path (indicated by the dashed line in FIG. 1) corresponding to each station line laid inside the transmission control apparatus 10.

With the foregoing configuration, a speech signal outputted from each telephone 31 is received through the corresponding extension line and the transmission control apparatus 10 by a subscriber (extension line) interface of the PBX (a), and connected to one station line inside the PBX (a), and transmitted from the station line interface of the PBX (a) through the transmission control apparatus 10 and the appropriate station line to an exchange 40 inside the telephone station.

On the other hand, the speech signal outputted from the exchange 40 to one station line is received through the station line and the transmission control apparatus 10 by the station line interface of the PBX (a), connected to a particular extension line, outputted from the subscriber interface of the PBX (a) toward the particular extension line, and transmitted through the transmission control apparatus 10 and the particular extension line to the corresponding telephone 31.

Moreover, the speech signal from a certain telephone 31 inputted to a subscriber interface through a certain extension line is sent from the subscriber interface of the PBX (a) to a particular different extension line and sent through the transmission control apparatus 10 and the particular different extension line to a different telephone 31.

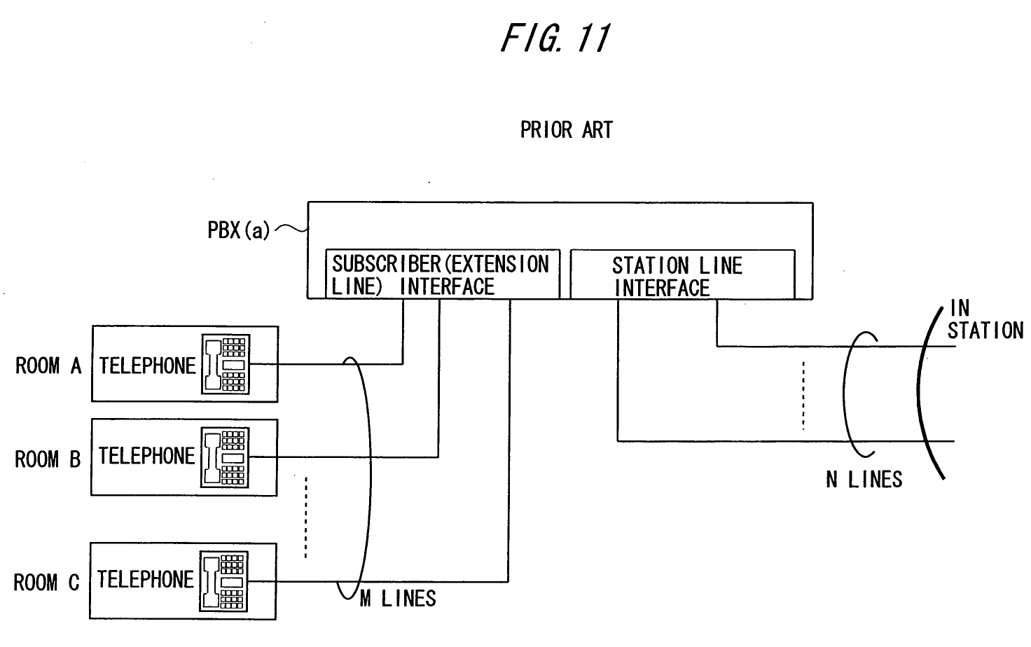

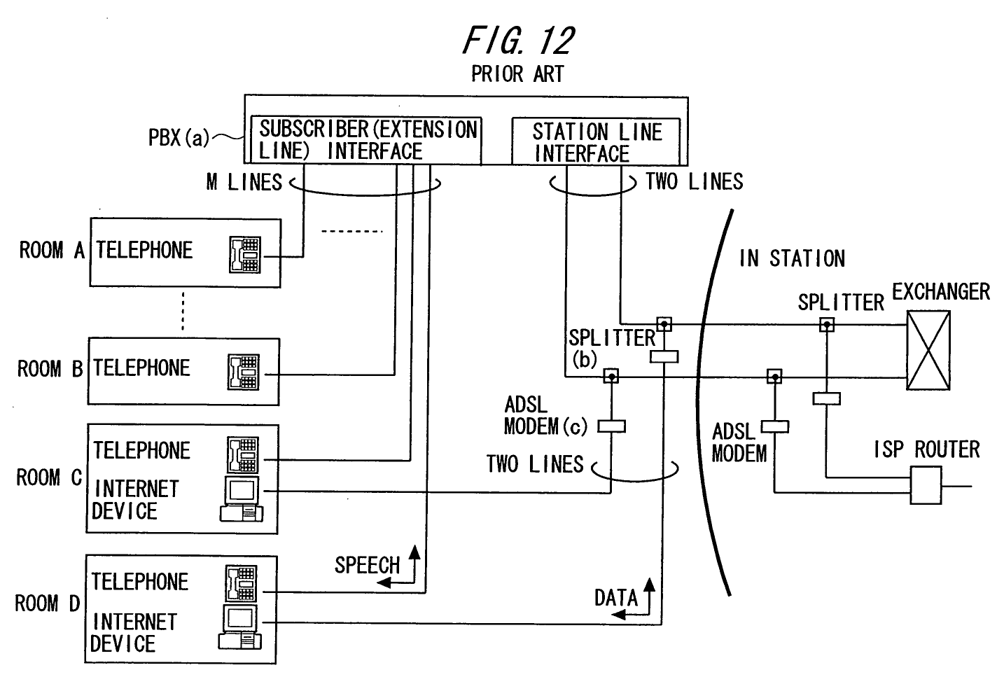

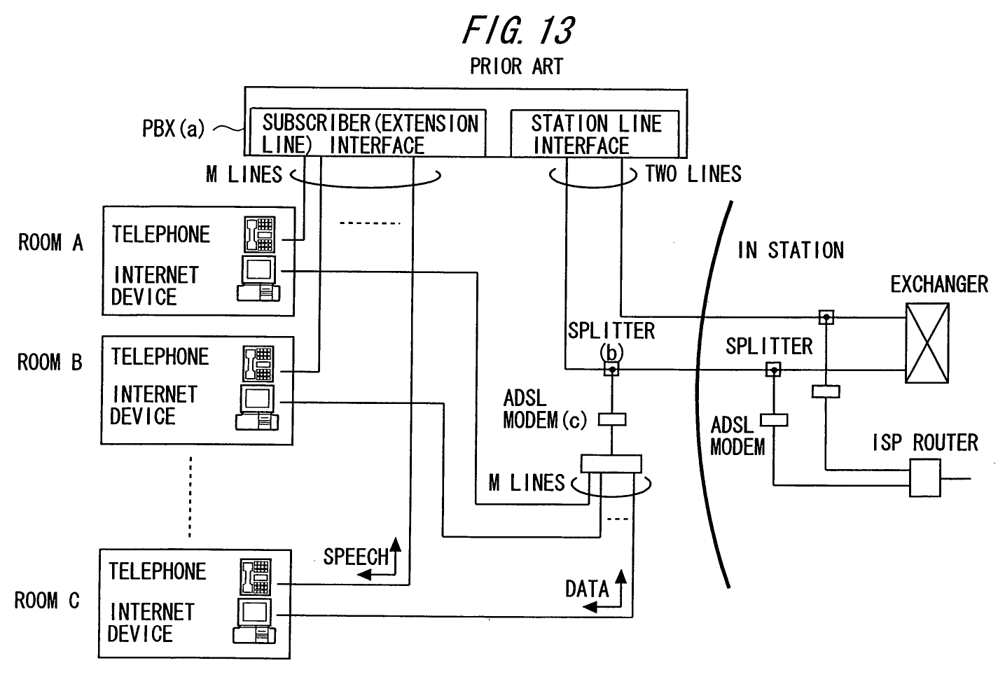

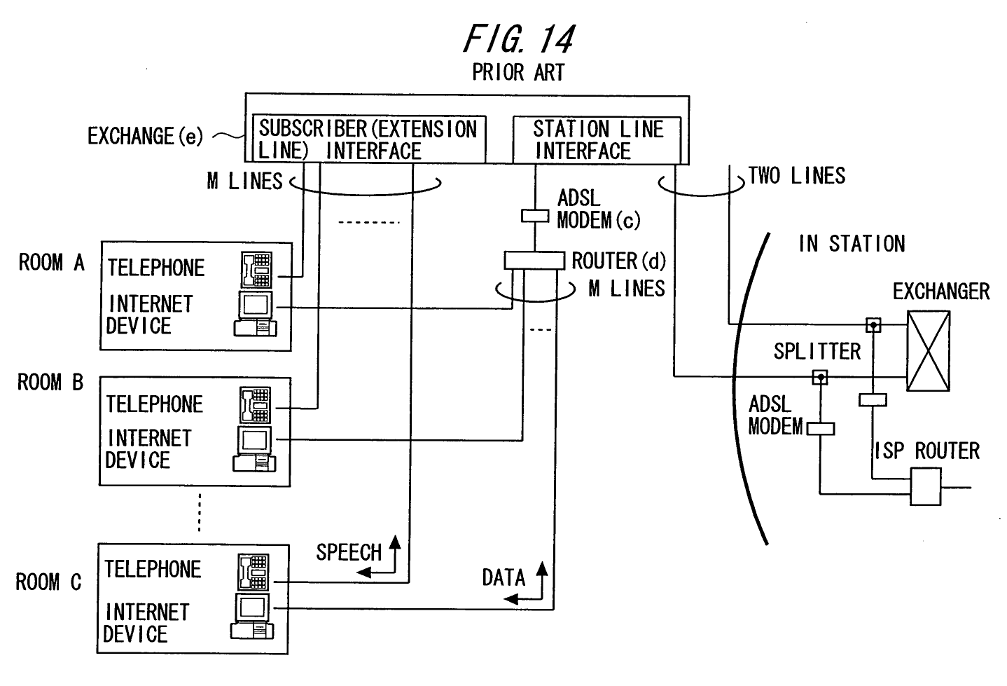

In this way, each telephone 31 can carry out a call through the PBX (a) to the outside or carry out a call between the telephones 31. That is, the telephone extension line system similar to the conventional case (FIG. 11) can be attained through the transmission control apparatus 10.

Incidentally, the system shown in FIG. 1 is configured as follows, in order to prepare a connection environment to the Internet for each installation place of the telephone 31 (for example, a room of a hotel).

A splitter 33 for inserting a data signal into the extension line and isolating the data signal from the extension line is inserted into the extension line laid for each installation place (room) of the telephone 31. The splitter 33 is connected to an ADSL modem 34 for performing a modulation/demodulation on the data signal through a data signal line to transmit the data signal isolated from the extension line and the data signal to be inserted into the extension line. For this ADSL modem 34, an Internet device 32 having a connection function to the Internet is detachably configured. For example, a modular jack for connecting the Internet device 32 to the ADSL modem 34 is installed in the room, and a user can connect the Internet device 32 to the modular jack and accordingly connect the Internet device 32 to the ADSL modem 34. However, the connection manner of the Internet device 32 to the ADSL modem 34 may be the foregoing wired manner or may be the connection using non-contact communication such as a radio LAN.

On the other hand, externally, an ISP (Internet Service Provider) router 50 is connected through an ADSL modem 51 and a splitter 52, which are prepared for each station line, to each station line. The ISP router 50 is configured so as to be able to receive a data from each station line and send a data on the Internet to each station line.

The transmission control apparatus 10 according to the present invention has the following configuration, in order to connect each Internet device 32 to the ISP router 50 (Internet). That is, the transmission control apparatus 10 has: a splitter 15 on the extension line side which is prepared for each extension line and isolates/inserts the data signal from/into each extension line; a splitter 16 on the station line side which is prepared for each station line and isolates/inserts the data signal from/into each station line; a selector switch (selector SW) 17 which is connected through the data signal line to the respective splitters 15, 16 and connects/disconnects any extension line and station line; and a control unit 18 for controlling a connecting/disconnecting operation of the selector switch 17.

When a certain Internet device 32 (for example, the Internet device 32 in a room A) is used to use the Internet, an extension line of the room A and one station line are connected by the control of the selector switch 17 of the control unit 18.

Thus, between the Internet device 32 of the room A and the ISP router 50, a transmission route of the data signal is generated such as the ADSL modem 34-the splitter 33-the extension line of the room A-the splitter 15-the selector switch 17-the splitter 16-one station line-the splitter 52-the ADSL modem 51. By using the data transmission path, the Internet device 32 can be connected to the Internet, and the data can be transmitted and received between the Internet device 32 and the ISP router 50.

The foregoing operation is similarly carried out even by using the Internet device 32 in any room. That is, the extension line of the room where the Internet device 32 exists and one station line are connected by the selector switch 17, the data transmission path is generated between the Internet device 32 and the ISP router 50, and the connection to the Internet and the transmission/reception of the data are carried out through this data transmission path.

In this way, the transmission control apparatus 10 carries out the transmission control of the data signal, making it possible to prepare a connection environment to the Internet for the installation place of each extension line without modifying the telephone extension line system using the PBX(a) The connection environments to the Internet can be prepared correspondingly to the number of the extension lines.

The operation of the transmission control apparatus 10 as described above can be carried out by using the extension line telephone (telephone) 31. In the example shown in FIG. 1, the transmission control apparatus 10 is connected to the PBX (a) through an extension line control speech line 19. The telephone 31 is configured so as to be able to input a control signal (a request signal for the Internet usage) instructing a connection between the appropriate extension line and the external line.

The control signal inputted from the telephone 31 passes through the extension line and arrives at the PBX (a), and passes from the PBX (a) through the extension line control speech line 19, and enters the transmission control apparatus 10. The control signal inputted to the transmission control apparatus 10 is given to the control unit 18. Then, the control unit 18 controls the selector switch 17 in accordance with the control signal and connects a desired extension line and external line. In this way, the transmission control apparatus 10 can be configured so as to be remotely operable by using the extension line telephone 31.

Also, the transmission control apparatus 10 can be configured so as to be manually operable. In the example shown in FIG. 1, an operation panel 20 of the transmission control apparatus 10 is prepared and connected to the transmission control apparatus 10. The operation panel 20 is configured so as to be able to input a connection instruction between any extension line and external line. The connection instruction inputted to the operation panel 20 is inputted to the transmission control apparatus 10 and passed to the control unit 18. Then, the control unit 18 controls the selector switch 17 in accordance with the connection instruction and connects the desired extension line and external line.

In this way, the transmission control apparatus 10 according to the present invention is installed in the state where the transmission control apparatus 10 is inserted between the PBX (a) and the subscriber line (both of the extension line and the station line). The transmission control apparatus 10 has the selector switch 17 having a switching function. The splitter 15 is installed on the connection side of the extension line, and the splitter 16 is installed on the connection side of the station line, respectively individually (for each line). Thus, the speech signal is conventionally connected through the PBX (a) between the extension line and the external line, and the data signal is connected between the extension line and the external line without any intervention of the PBX (a).

Even with the viewpoint of facility introduction, nothing is required except an easy wiring work for connecting the transmission control apparatus according to the present invention between the PBX and the subscriber lines (both of the extension line and the station line). In each room, the splitter 33 and the ADSL modem 34 are used to isolate the speech signal and the data signal. For this reason, the introduction of the facility is possible without any execution of a large scale wiring work such as the establishment of the LAN inside the hotel.

FIG. 2A shows the detailed configuration of the transmission control apparatus 10 shown in FIG. 1. In FIG. 2A, the 30 extension lines are used, and the 2 station lines are used. Also, as an example of the selector switch 17, here, a switch using a relay is assumed, and the enlarged drawings of the switch units on the extension line side and station line side are shown in FIG. 2B.

As shown in FIG. 2A, the transmission control apparatus 10 has the extension line interface 11, the station line interface 12, the PBX (extension line) interface 13, and the PBX (station line) interface 14.

The splitters 15, 16 are inserted into the transmission paths of the signals for the respective extension lines and station lines passing through the transmission control apparatus 10, respectively, and the respective splitters 15, 16 are connected to the selector switch 17 through the data signal lines.

The selector switch 17 is connected to the control unit 18 through a control line. The control unit 18 has a control operation unit 18A, a voice response unit 18B, a PB_Decoder unit (also, noted as [Decoder Unit]) 18C, and a time monitoring, charging unit 18D.

The transmission control apparatus 10 has; a speech signal interface 21 for accommodating the extension line control speech line 19 connected to the PBX (a); and an operation panel interface 22 for accommodating the data line and control line from the operation panel 20. The speech signal interface 21 and the operation panel interface 22 are connected to the control unit 18, respectively.

The functions of respective blocks shown in FIG. 2A are as follows. The control unit 18 controls the selector switch 17, in accordance with a request (PB (Push Button)/Speech signal) from the extension line telephone (telephone) 31 or an operation request from the operation panel 20. Also, the control unit 18 has functions for setting and monitoring a time, carrying out a charging, and the like, and controls the entire transmission control apparatus 10.

The control operation unit 18A has functions for receiving the request from the PB_Decoder unit 18C or operation panel 20 and controlling the selector switch 17.

The voice response unit 18B has functions for receiving the request from the PB_Decoder unit 18C and responding to the user with a speech.

The PB_Decoder unit 18C terminates and recognizes (analyzes) the PB/speech signal from a speech signal interface (p), and carries out an answer instruction request to the voice response unit 18B, an operation (control) request of the selector switch 17 to the control operation unit 18A, and a setting notification of a communicable time (also noted as [Usage Time of Internet], [Connection Time of Internet]) to the time monitoring/charging unit 18D, in accordance with the request from the extension line telephone 31. Also, the PB_Decoder unit 18C carries out a wait state setting and a usable notification of the user if all of the switches inside the selector switch 17 are used.

The time monitoring/charging unit 18D carries out monitoring the communicable time and charging, in accordance with a notification from the PB_Decoder unit 18C.

The operation panel 20 has input apparatuses such as a setting dial and a keyboard, and an output apparatus such as a display (LCD and the like). The operation panel 20 has a function for an administrator to perform (operate) the operation request for the control unit 18 directly by using the setting dial, the keyboard input, or the like, rather than depending on the request from the extension line telephone 31. Also, the operation panel 20 has a function for outputting the usage state of the Internet of the user notified by the control unit 18 to the output apparatus.

The selector switch 17 has a plurality of relay contacts (FIG. 2B) to connect/disconnect any extension line and external line as mentioned above. By connecting/disconnecting the relay contacts on the basis of the request from the control unit 18, the selector switch 17 connects/disconnects the route of the data signal between the station line and the extension line. Note that as the selector switch 17, a spatial switch composed of a relay, an electronic contact, and the like shown in FIGS. 2A and 2B are used, and a time switch is not used.

The splitter 15 has a function for isolating the speech signal and the data signal on the extension line side inside the transmission control apparatus 10 and sending the data signal to the selector switch 17. Also, the splitter 15 has a function for receiving the data signal isolated from the station line through the selector switch 17 and inserting the received data signal into the corresponding extension line in the transmission direction from the PBX (a).

The splitter 16 has a function for isolating the speech signal and the data signal on the station side inside the transmission control apparatus 10 and sending the data signal to the selector switch 17. Also, the splitter 16 has a function for receiving the data signal isolated from the extension line through the selector switch 17 and inserting the received data signal into the corresponding station line in the transmission direction from the PBX (a).

The PBX interfaces 13, 14 are the interface units for connecting the transmission control apparatus 10 and the PBX (a). The extension line interface 11 is the interface unit for connecting the transmission control apparatus 10 and the extension line. The station line interface 12 is the interface unit to connect the transmission control apparatus 10 and the station line.

The operation panel interface 22 is the interface for connecting the transmission control apparatus 10 and the operation panel 20. The speech signal interface 21 is the interface of the speech signal for carrying out a request to the transmission control apparatus 10 and an announcement to the user. Also, the operation panel interface 22 has an interface function of a telephone oscillation signal (push button signal).

According to the system shown in FIG. 2A, when the user in the room A uses the Internet in the room A, the Internet device 32 is connected to the modular jack for Internet device connection prepared in the room A. Thus, the Internet device 32 is connected to the ADSL modem 34. Note that the Internet device 32 may be prepared by the user itself or may be lent from the hotel.

Subsequently, the user uses the extension line telephone 31 in the room A and dials an extension line telephone number for Internet connection. Then, the control signal (the usage request for the Internet) to the transmission control apparatus 10 is inputted through the extension line to the PBX (a), and inputted from the PBX (a) through the extension line control speech line 19 to the transmission control apparatus 10. Then, the control unit 18 controls the selector switch 17 and connects the extension line of the room A to any station line. Thus, the user in the room A can operate the Internet device 32, thereby using the Internet at a remote location (in the room A).

Also, the user in the room A calls a reception (administrator) of the hotel and informs the usage of the Internet. The administrator operates the operation panel 20 and sends the usage request of the Internet to the control unit 18. Then, the control unit 18 instructs the selector switch 17 to carry out a switching operation and connect the extension line of the room A and any station line. Thus, the user can use the Internet in the room A.

By the way, when the user in the room A uses the extension line telephone 31 to call the outside, the usage fee is charged by the PBX (a). In contrast, in the charging when the Internet is used, instead of the PBX (a) which is used in the case of the speech communication, the time monitoring/charging unit 18D inside the control unit 18 of the transmission control apparatus 10 is used to carry out the charging.

The PB_Decoder unit 18C inside the control unit 18 terminates and recognizes the PB/speech signal, notifies the user of the result from the voice response unit 18B, and notifies the control operation unit 18A of the connection or disconnection of a selector switch (h). Thus, the user can operate the transmission control apparatus 10 at a remote location.

Also, the transmission control apparatus 10 is configured such that the control operation unit 18A and the PB_Decoder unit 18C are notified of the usage state of the selector switch 17. Accordingly, the response as to whether or not the Internet can be used is sent through the extension line telephone 31 to a usage requester for using the Internet by the operation of the voice response unit 18B. Hence, the user, when using the extension line telephone 31 for requesting the usage of the Internet, can tell whether or not the Internet can be used, from the response (speech output) from the extension line telephone 31.

With regard to the request for the usage of the Internet, if all of the contacts of the selector switch 17 are used, the selector switch 17 cannot carry out the connection process corresponding to the request. The control operation unit 18A and the decoder unit 18C are notified of such an unusable state of the selector switch 17. In this case, the voice response unit 18B transmits the response indicating that the Internet cannot be used, as the response to the usage request, through the extension line telephone 31 to the user.

In the case where the response indicating that the Internet cannot be used is sent to the usage requester, the transmission control apparatus 10 can be further configured such that the voice response unit 18B transmits guidance of a setting under the unusable state of the Internet through the extension line telephone 31 to the usage requester.

With this configuration, the user can carry out the setting at the time of the unusable state in accordance with the response (guidance) from the voice response unit 18B. The setting at the time of the unusable state is the setting to inform (notify) the user, for example, of the fact that the selector switch 17 is shifted from the unusable state to the usable state (that the state of the selector switch 17 becomes the state in which the connection process corresponding to the usage request can be executed, namely, the state in which the Internet can be used) when such a state is attained. The notification can be issued to the user, for example, by originating the call of a usable notification to the appropriate extension line telephone 31 (for example, ringing the appropriate extension line telephone 31).

With this configuration, in the case where the user cannot immediately use the Internet, performing the setting in the unusable state makes it possible for the user to be informed of the fact as to when the Internet becomes in the usable state, and by sending again the usage request when the Internet becomes in the usable state, the user can use the Internet.

According to the transmission control apparatus 10 according to the present invention, inside a building such as a hotel or an office in which the PBX (a) is installed, the simple connection work of connecting the transmission control apparatus 10 between the PBX (a) and the subscriber lines (both of the extension line and the external line) enables the Internet to be used from the extension line.

The wiring and connecting method when the transmission control apparatus 10 according to the present invention is used to use the Internet involves merely connecting the transmission control apparatus 10 between the existing PBX (a) and the subscriber lines (both of the extension line and the station line). Thus, only an easy connection work is required to be able to arrange the usage environment of the Internet.

Also, in each room, for the already-laid telephone line (extension line), the configuration for using the splitter 33 and the ADSL modem 34 to branch the speech signal and the data signal is used. Thus, the establishment of the private LAN using the router and the like and a large scale wiring work are not required.

The user connects the Internet device 32 to the modular jack for the Internet connection, among the modular jacks wired to each room, and calls the extension line telephone number for the Internet connection, and then carries out the setting in accordance with the instruction of the voice announcement outputted from the extension line telephone 31. Thus, the Internet can be used in the room of the user.

At this time, the connection time of the Internet can be set (when it is not set, a default time can be set). When the connection time is set, the charging of the excessive fee caused by forgetting about disconnecting the line can be protected.

Also, the extension line and the station line are connected through the transmission control apparatus 10 according to the present invention to transmission for the data signal, the extension line and the station line are connected through the PBX (a) to transmission for the speech signal. Thus, the user can use the extension line and the external line telephone similarly to the prior art, even when the Internet is used.

The usage of the transmission control apparatus 10 according to the present invention causes all of the data signals to pass through the transmission control apparatus 10 and causes only the speech signal to pass through the PBX (a). Thus, any additional new function or change to the PBX (a), or any new development of the exchange to replace the PBX (a) are not required. Also, as described above, no additional new facility nor the wiring work is required, so the cost can be suppressed.

### Embodiment

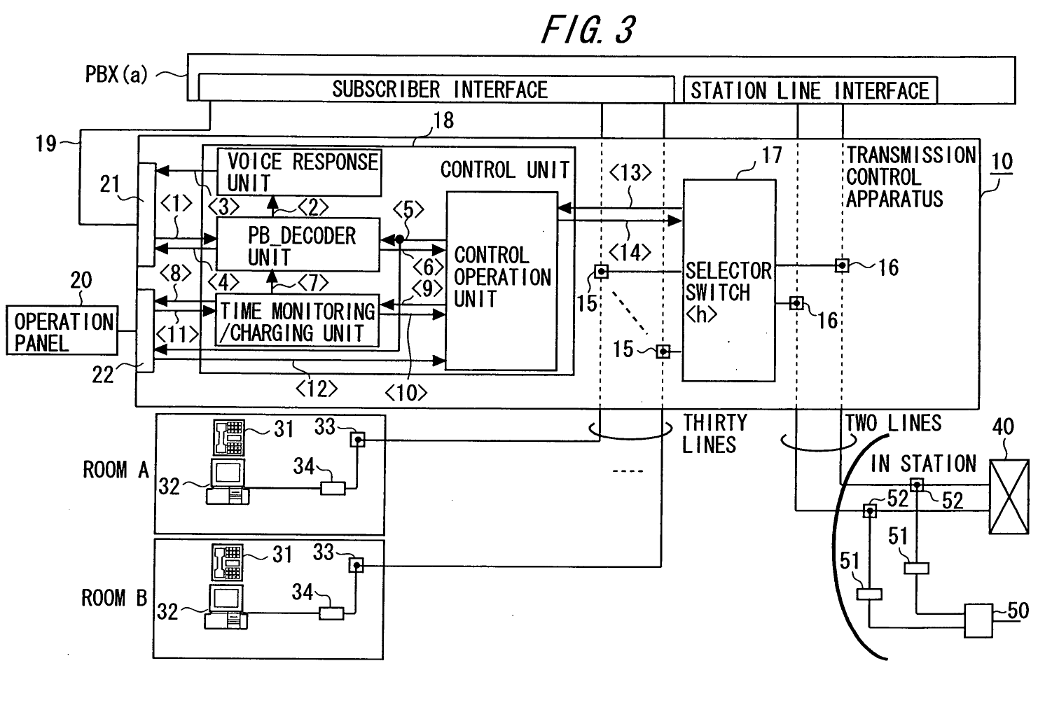

As the embodiment of the transmission control apparatus according to the present invention, the case where the transmission control apparatus 10 is installed in a hotel and the Internet can be used from each room of the hotel is explained. FIG. 3 is a view showing the action and operation examples of the transmission control apparatus 10, and signal lines <1> to <14> shown by arrows in FIG. 3 indicate the following contents. In accordance with the actions to the transmission control apparatus 10, the suitable actions among the actions indicated in <1> to <14> are carried out inside the transmission control apparatus 10.

<1>: The speech signal interface 21 sends the request signal from the user, such as the connection and the setting, to the PB_Decoder unit (decoder unit) 18C of the control unit 18. The request signal (control signal) is the extension line telephone number (push button (dial) signal) which the user of the Internet inputs by using the extension line telephone 31 of the rental room, and is received through the extension line of the room, the transmission control apparatus 10, the PBX(a), and the extension line control speech line 19 by the speech signal interface 21 of the transmission control apparatus 10.

<2>: The decoder unit 18C decodes the request signal, recognizes (analyzes) the content, and sends a response instruction signal with regard to the request from the user to the voice response unit 18B, in accordance with the analyzed result.

<3>: The voice response unit 18B generates a voice response signal with regard to the request from the user, and sends the signal to the speech signal interface 21. The voice response signal is outputted from the speech signal interface 21 to the extension line control speech line 19, and outputted through the PBX(a) and the transmission control apparatus 10 to the appropriate extension line, and outputted from the corresponding extension line telephone 31.

<4>: The decoder unit 18C, when the selector switch 17 becomes in the usable state, notifies the user to that effect by using the telephone call. That is, a telephone call signal to the appropriate extension line is sent to the speech signal interface 21, and inputted through the extension line control speech line 19 to the PBX (a) The PBX (a) outputs the telephone call signal to the appropriate extension line, and the signal is transmitted to the extension line telephone 31.

<5>: The control operation unit 18A notifies the decoder unit 18C of the usage state of the selector switch 17. The operation panel 20 is also notified of the usage state through the operation panel interface 22.

<6>: The decoder unit 18C sends the connection/disconnection request for the selector switch 17 based on the request from the user to the control operation unit 18A.

<7>: The decoder unit 18C notifies the time monitoring/charging unit 18D of the connection time set by the user or set to the default setting and the extension line number of the user.

<8>: The time monitoring/charging unit 18D notifies the operation panel 20 of the connection state of the selector switch 17 and the charging information of the connected user (extension line number) through the operation panel interface 22.

<9>: The control operation unit 18A notifies the time monitoring/charging unit 18D of the connection/disconnection of the selector switch 17 based on the request from the user.

<10>: The time monitoring/charging unit 18D examines the set time (connection time) with regard to the usage of the Internet, and if there is a case of exceeding the set time, notifies the control operation unit 18A of a disconnection request signal for the selector switch 17 with regard to the connection between the appropriate extension line and station line.

<11>: If the usage time (connection time) of the Internet set by using the operation panel 20 is set, the connection time is inputted from the operation panel interface 22 to the transmission control apparatus 10 and the time monitoring/charging unit 18D is notified of the connection time.

<12>: If the operation panel 20 is used to control the usage of the Internet (the connection between the extension line and the station line is controlled), the connection/disconnection request signal for the selector switch 17 generated by the action of the operation panel 20 is directly sent through the operation panel interface 22 to the control operation unit 18A.

<13>: The selector switch 17 notifies the control operation unit 18A of the usage state (usable state or unusable state).

<14>: The control operation unit 18A notifies the selector switch 17 of the control signal for the connection/disconnection of the selector switch 17 to carry out the connection/disconnection between any extension line and external line, on the basis of the request from the user of the Internet.

The operations of the transmission control apparatus 10 will be described below along several operation examples.

### OPERATION EXAMPLE 1

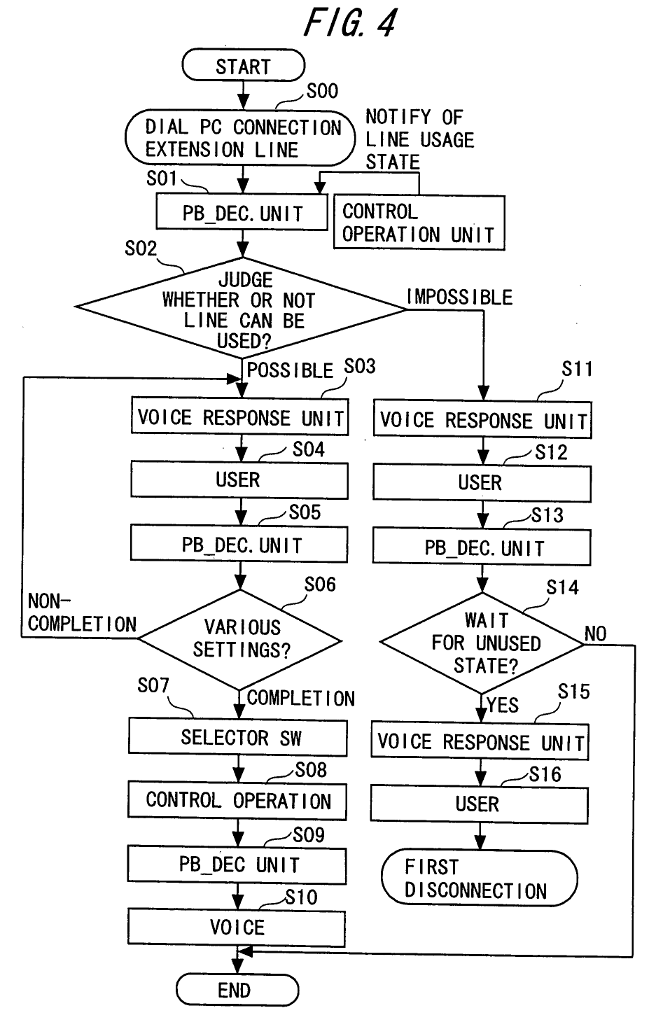

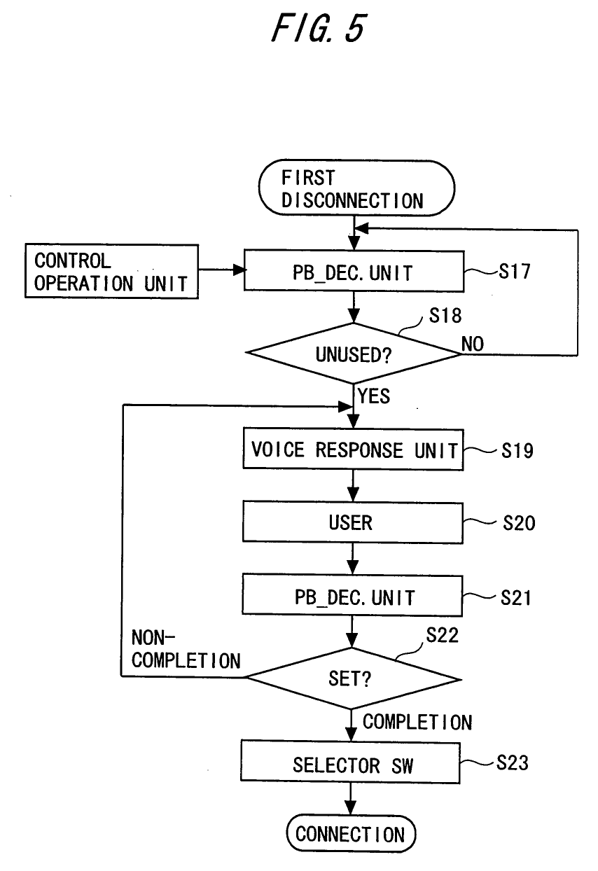

As the operation example 1, the operation example in the case in which the user of each room operates the transmission control apparatus 10 by using the extension line telephone 31 and then uses the Internet is explained. FIGS. 4 and 5 are flowcharts showing the operations of the transmission control apparatus 10 based on the operation example 1.

A user of a certain room, if desiring to use the Internet in the room, connects the Internet device 32 to the ADSL modem 34 in advance by using a setting method specified by ISP. Subsequently, the user uses the extension line telephone 31 to dial the extension line telephone number for the Internet connection (S00). The dialed signal is received as the request signal for the usage of the Internet (the signal for desiring the Internet connection) through the extension line control speech line 19 by the transmission control apparatus 10 and notified to the decoder unit 18C (FIG. 3; <1>).

The decoder unit 18C, when receiving the request signal, uses the usage state of the current Internet always notified of from the control operation unit 18A (here, the selector switch 17) to judge whether or not the connection to the Internet is possible (whether or not the line can be used), and notifies the voice response unit 18B of the judged result (S01, S02).

The selector switch 17 always notifies the control operation unit 18A of the usage state (FIG. 3; <13>). The control operation unit 18A always sends the usage state notification from the selector switch 17 to the decoder unit 18C (FIG. 3; <5>). Thus, the decoder unit 18C, when receiving the request signal, judges whether or not the notification indicating the unusable state of the selector switch 17 is received, and can accordingly judge the connection possibility or impossibility.

The voice response unit 18B outputs the speech signal of the voice announcement indicating the connection possibility or impossibility to the Internet, from the speech signal interface 21 to the extension line control speech line 19 (FIG. 3; <3>). Thus, the voice announcement is transmitted to the extension line telephone 31 which outputted the request signal, and outputted from the extension line telephone 31. In this way, the connection possibility or impossibility is notified to the user.

Here, if the judgment result of the connection possibility or impossibility is connectable (S02; Possible), the voice response unit provides the user with a notification of the speech signal indicating the voice announcement with regard to the fact that the connection to the Internet is possible and the various settings for the usage of the Internet (for example, a charging method (such as time charging and a fixed fee (corresponding to xx yen))) (S03) The user, when being notified that the connection is possible and receiving the voice announcement, inputs an answer as to whether or not to perform the connection and carries out the various settings such as the connection time and the like, in a predetermined procedure, in accordance with the voice announcement (S04). The inputs of the answer and setting are carried out by the action of the extension line telephone 31. When the answer and the setting are inputted to the extension line telephone 31, tone signals related thereto are outputted from the extension line telephone 31 to the extension line. The tone signals are inputted through the extension line control speech line 19 to the decoder unit 18C of the control unit 18 (FIG. 3; <1>).

The decoder unit 18C, when receiving the tone signals, decodes and analyzes the tone signals, and judges whether or not the various settings required to use the Internet have been completed (S06).

If the settings have not been completed (S06; Non-Completion), an instruction to notify the user with the voice announcement for the user to carry out the remaining settings is given to the voice response unit 18B (FIG. 3; <2>).

In this way, until the end of the setting, the loop process from S03 to S06 is repeated. Here, the decoder unit 18C, when receiving the connection time set by the user, notifies the time monitoring/charging unit 18D of the connection time (FIG. 3; <7>). However, if the setting of the connection time is not performed, the decoder unit 18C defines the prepared default time as the connection time and notifies the time monitoring/charging unit 18D of the prepared default time.

When the setting has been completed (S06; Completion), the decoder unit 18C gives to the control operation unit 18A, the request for connecting the extension line related to the usage request to the station line (FIG. 3; <6>). The control operation unit 18A controls the selector switch 17 for connecting the extension line related to the request and the station line (S07, FIG. 3; <14>).

When the extension line and the station line are connected, the ADSL modem 34 is connected to the ADSL modem 51 and the ISP router 50 on the station side, and a link up LED of the ADSL modem 34 is turned on. Also, the control operation unit 18A transmits a connection start signal to the time monitoring/charging unit 18D, and the time monitoring and charging are carried out (S08, FIG. 3; <9>). The time monitoring/charging unit 18D has a timer, and a time counting is started by the timer. The state of the control operation is outputted to the operation panel 20 (FIG. 3; <5>, <8>). However, whether or not the state is always outputted to the operation panel 20 can be selected.

When the connection between the extension line and the station line has been completed, the decoder unit 18C is notified of the connection completion from the control operation unit 18A (FIG. 3; <5>). Then, the decoder unit 18C carries out an instruction for notifying the voice response unit 18B of the connection completion (S09; FIG. 3; <2>).

The voice response unit 18B notifies the user of the connection completion with the voice announcement (S10, FIG. 3; <3>). As described above, the Internet device 32 is connected to the Internet. Thus, the user can perform the desirable action on the Internet device 32 and use the Internet. Incidentally, the speech signal is transmitted through the PBX (a) without passing through the selector switch 17. Thus, the internal/external calls by using the extension line telephone can be carried out as usual.

By the way, in the step S02, if the decoder unit 18B judges that the connection to the Internet is impossible (S02; Impossible), the voice response unit 18B, sends to the user, the voice announcement as the speech signal indicating the execution of the setting to select the end of the procedure for the Internet usage, or to select the reception of the notification in the case where it becomes to be in the state where the Internet connection is possible (S11, FIG. 3; <3>).

The user carries out the setting of the procedure end or notification reception, through the button action of the extension line telephone, in accordance with the voice announcement outputted from the extension line telephone 31 (S12). Through the button action, the tone signal and/or dial signal indicating the procedure end or notification reception is sent from the extension line telephone 31 to the extension line, and inputted through the PBX(a) and the extension line control speech line 19 to the decoder unit 18C of the transmission control apparatus 10 (FIG. 3; <1>).

Then, the decoder unit 18C decodes and analyzes the input tone/dial signal and judges that which of the procedure end or the notification reception (whether or not an unused (idle)) state is waited for) is indicated by the signal (S13, S14). At this time, if the analyzed result is the procedure end (S14; NO), the process is ended.

On the other hand, if the analyzed result is the notification reception (S14; YES), the decoder unit 18C, when the notification from the control operation unit 18A is shifted to the usable state, performs a self-setting to carry out a telephone transmission indicating the usable state on the extension line telephone, and also gives a notification instruction of the setting completion of the notification reception to the voice response unit 18B (FIG. 3; <2>).

The voice response unit 18B sends the voice announcement of the setting completion of the notification reception to the extension line telephone 31 of the user (FIG. 3; <3>). The user, when the setting completion of the notification reception is notified, transiently disconnects the line of the extension line telephone 31 (S16). Then, the user waits for the incoming call of the notification of the usable state.

As described above, if the state of the selector switch 17 is the unusable state so that the Internet cannot be immediately used, the user can perform the settings to wait for the state becoming usable, and to be notified that the state has become usable (the setting for waiting to be notified that the Internet can be used) on the transmission control apparatus 10.

Note that a contact wait queue is installed in the decoder unit 18C, and a setting of a contact waiting from a plurality of users is configured so as to be able to be registered in the contact wait queue in the reception order.

Also, the extension line telephone number for a re-trial in a case where the extension line telephone line is disconnected while the transmission control apparatus 10 is operated by the user is prepared, which enables the user to carry out the re-try from where the action should be interrupted halfway through.

In the setting in which the user waits for the contact, as shown in FIG. 5, the decoder unit 18C monitors the notification from the control operation unit 18A and repeats the process for judging whether or not the state of the selector switch 17 is the usable state (unused state) (S17, S18).

The decoder unit 18C, when receiving the notification of the usable state from the control operation unit 18A (S18; YSE (exist)), specifies the oldest setting time in the settings registered in the contact wait queue, carries out the calling to the extension line telephone 31 corresponding thereto, and instructs the voice response unit 18B to output the speech signal (FIG. 3; <2>).

The voice response unit 18B sends the voice announcement indicating that the Internet can be used to the appropriate extension line telephone 31, in accordance with the instruction from the decoder unit 18C (FIG. 3; <3>).

Accordingly, when the appropriate extension line telephone 31 is called up (ringed) and the user responds to the call (Off-Hook) the voice announcement indicating the usable state is notified to the user (S04). After that, the processes similar to the steps S05 to S10 are carried out (S21 to S23), and the user can use the Internet. Incidentally, if the user does not respond to the call for a predetermined time, this contact waiting process is ended.

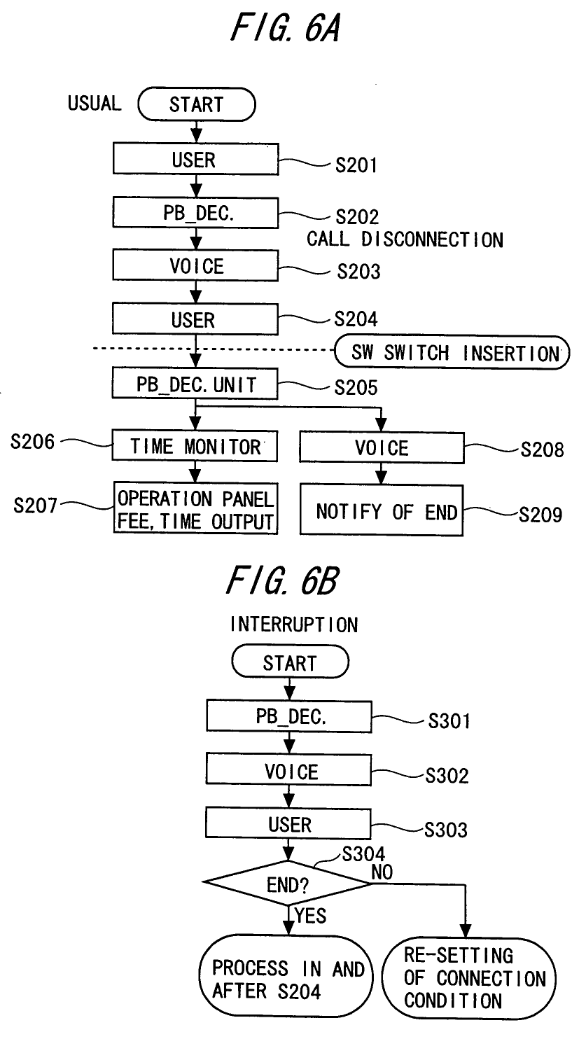

Next, when the user ends the usage of the Internet, the actions indicated in the flowcharts in FIGS. 6A and 6B and the operations of the transmission control apparatus 10 are performed.

In FIG. 6A, the user, when ending the usage of the Internet, dials the transmission control apparatus 10 from the extension line telephone 31 and requests the disconnection of the connection. That is, when the user uses the extension line telephone 31 and dials the extension line telephone number for the Internet end (S201), the PB signal corresponding to this is inputted through the extension line control speech line 19 to the decoder unit 18C, and the decoder unit 18C gives a speech output instruction to the voice response unit 18B (S202).

The voice response unit 18B outputs the voice announcement at the time of the Internet end in accordance with the instruction from the decoder unit 18C, and the voice announcement is transmitted to the extension line telephone 31 (S203).

When the user inputs the setting of the connection end (disconnection; call open) to the extension line telephone 31 in accordance with the voice announcement, the tone signal based on this setting is transmitted to the decoder unit 18C (S204).

The decoder unit 18C, when receiving the setting of the disconnection, gives a control instruction for the selector switch 17 to the control operation unit 18A, and the control operation unit 18A controls the selector switch 17 in accordance with the control instruction and disconnects the connection between the appropriate extension line and station line.

The decoder unit 18C, when the connection is disconnected, notifies the time monitoring/charging unit 18D of a monitor signal (indicating the disconnection) of the connection process and accordingly instructs the time monitoring/charging unit 18D to carry out a settlement process (S205).

The time monitoring/charging unit 18D stops counting the connection time between the appropriate extension line and station line, calculates a fee based on this connection time, and outputs the connection time and the fee through the operation panel interface 22 to the operation panel 20 (S206, FIG. 3; <8>). An output apparatus of the operation panel 20 displays the connection time and fee which are received from the time monitoring/charging unit 18D (S207).

On the other hand, the decoder unit 18C gives the speech output instruction to the voice response unit 18B (S205). The voice response unit 18B outputs the speech signal indicating the end of the disconnection process through the speech signal interface 21 to the extension line telephone 31 of the user, in accordance with the speech output instruction (S208). Thus, the user can hear the end of the disconnection process via the extension line telephone 31 (S209).

After that, the user clears the usage fee of the Internet at the reception of the hotel, for example, at the time of a checkout. Various manners for a payment including a payment in cash or by a credit card can be applied to a payment manner of the fee at this time.

By the way, if the connection time of the Internet exceeds the time and fee which are set by the user when the Internet is connected, an interruption process as shown in FIG. 6B is performed.

While the Internet is connected, the time monitoring/charging unit 18D counts the connection time. If the time counted by the time monitoring/charging unit 18D exceeds the connection time set by the user or the connection time based on the fee set by the user, the decoder unit 18C detects the excess of the time and gives the speech output instruction to the voice response unit 18B (S301).

The voice response unit 18B sends the speech signal (voice guidance) indicating the excess of the set connection time and fee and a query with regard to the end or continuation of the usage, through the internal call to the user (S302).

The user decides to end or continue the usage, in accordance with the voice guidance outputted from the extension line telephone 31 (S303, S304). At this time, if the user ends the usage of the Internet, the processes and actions in and after the step S205 shown in FIG. 5A are carried out, and the disconnection process and the settlement process of the fee are performed. On the contrary, in the case where the user continues the usage, the re-setting of the connection condition is carried out by using the internal line call, and the connection state between the appropriate extension line and station line is maintained.

Note that the foregoing example is configured such that the end or continuation of the usage of the Internet can be queried to the user. Alternatively, when the decoder unit 18C detects the excess of the connection time or fee, the instruction of the disconnection is given to the control operation unit 18A, and the control operation unit 18A may control the selector switch 17 for disconnecting the connection between the appropriate extension line and station line.

### OPERATION EXAMPLE 2

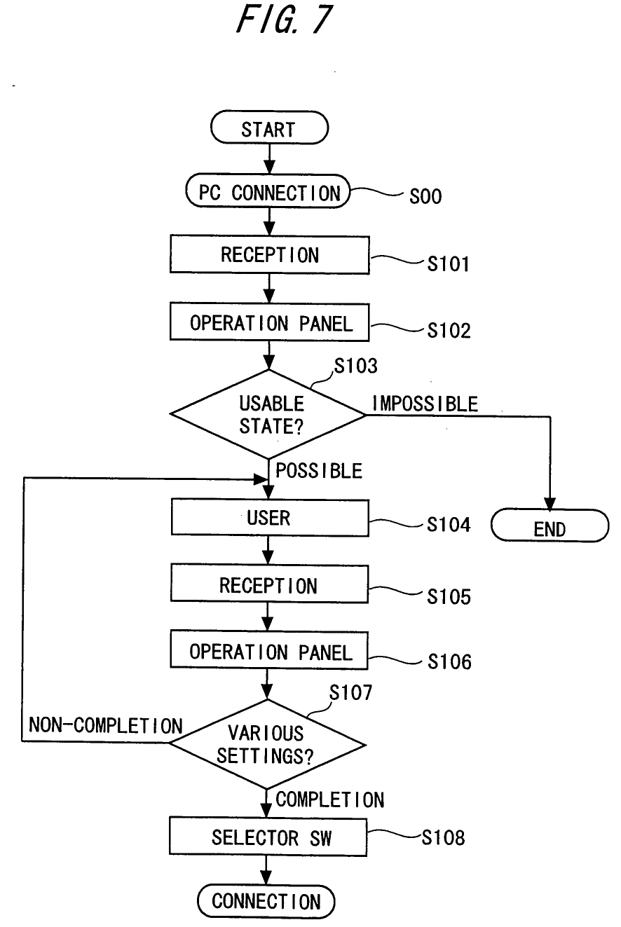

As an operation example 2, the operation example is explained in which the operation panel 20 is used to use the Internet. FIG. 7 is a flowchart showing the operations of the transmission control apparatus 10 based on the operation example 2.

The user of each room, if desiring to use the Internet in the room, connects the Internet device 32 to the ADSL modem 34 by using the setting method specified by the ISP in advance, similarly to the operation example 1 (S00).

The user uses the extension line telephone 31 of the room, makes an internal call to the reception of the hotel, and notifies the administrator (operator) of the transmission control apparatus 10 at the reception of the intention of the Internet usage. The administrator refers to the usage state of the selector switch 17 that is outputted to the output apparatus of the operation panel 20, and determines the connection possibility or impossibility to the Internet (S101, S102 and S103).

At this time, if the connection to the Internet is impossible (S103; Impossible), the administrator makes an internal call to the user to notify that the Internet can not be used. On the other hand, if the connection to the Internet is possible (S103; Possible), the administrator notifies the user of the connection possibility (S104), asks the user about the information related to the usage of the Internet, such as the connection time (charging time) and the telephone number of the connection ISP (S105), and inputs the various settings to the operation panel 20 (S106).

The various setting contents (the connection instruction between the extension line and the station line, the connection time (charging method), and the like) inputted to the operation panel 20 are inputted from the operation panel interface 22 to the transmission control apparatus 10. Then, the connection instruction is inputted to the control operation unit 18A (FIG. 3; <12>), and the connection time (charging method) is inputted to the time monitoring/charging unit 18D (FIG. 3; <11>).

In this way, when the various settings for the transmission control apparatus 10 have been ended (S107; Completion), the control operation unit 18A controls the selector switch 17 for connecting the extension line and the station line in accordance with the request (S108).

Then, the ADSL modem 34 is connected to the ADSL modem 51 on the station side and to the ISP router 50, and the link up LED of the ADSL modem 34 is turned on. Also, the control operation unit 18A transmits the connection start signal to the time monitoring/charging unit 18D, and the monitoring and charging of the time are executed. Such a state is outputted to the operation panel 20 (the output can be selected to be constant or not).

As described above, the Internet device 32 is connected to the Internet, and the user can carry out the desirable action. Incidentally, since the speech signal is transmitted through the PBX (a) without any intervention of the selector switch 17, the internal and external calls by using the extension line telephone can be carried out as usual.

The user, when ending the usage of the Internet, uses the extension line telephone 31, and dials to call the reception to request the administrator to disconnect the connection. The administrator operates the operation panel 20 in accordance with the request of the user, and gives the request for disconnecting the selector switch 17 to the control operation unit 18A. The control operation unit 18A controls the selector switch 17 in accordance with the request from the operation panel 20, and disconnects the connection between the appropriate extension line and station line.

When the user is using the Internet, in a case of exceeding the connection time set by the user at the time of the connection, the time monitoring/charging unit 18D requests the control operation unit 18A to disconnect the connection because of the time excess (FIG. 3; <10>). The control operation unit 18A controls the selector switch 17 in accordance with the request from the time monitoring/charging unit 18D and disconnects the connection between the appropriate extension line and station line.

When the connection is disconnected, the control operation unit 18A receives a signal indicating the disconnection from the selector switch 17 and gives the monitor signal (the signal indicating the disconnection) of the connection state corresponding to this signal to the time monitoring/charging unit 18D (FIG. 3; <9>). Then, the time monitoring/charging unit 18D outputs the appropriate connection time and the fee based on the connection time to the operation panel 20 (FIG. 3; <8>).

After that, the user pays the fee corresponding to the usage of the Internet at the reception, for example, at the time of checking out the hotel.

### MODIFIED EXAMPLE

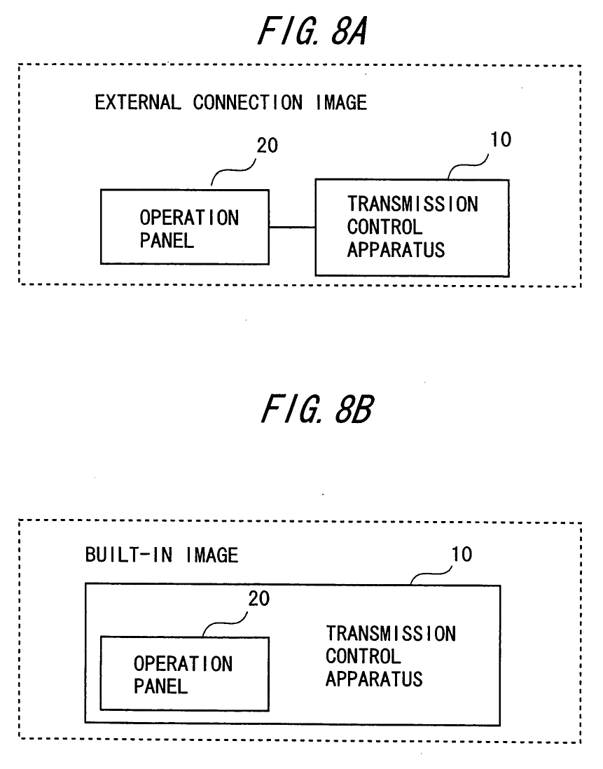

For the foregoing embodiment, the following modification is possible. In the foregoing embodiment, as shown in FIG. 3, the configuration is exemplified in which the transmission control apparatus 10 and the operation panel 20 are individually configured and the operation panel 20 is connected through the operation panel interface 22 installed in the transmission control apparatus 10 (FIG. 8A). On the contrary, as shown in FIG. 8B, the transmission control apparatus 10 can be configured such that the operation panel 20 is built therein.

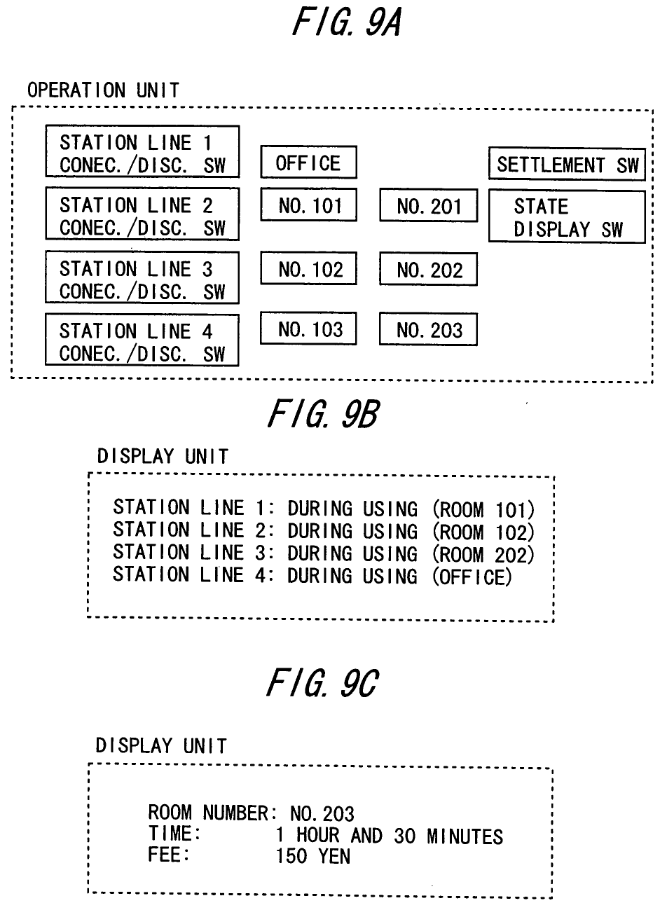

Also, the operation panel 20 explained in the embodiment can be configured as an apparatus having an operation unit and a display unit as shown in FIGS. 9A, 9B and 9C. That is, as shown in FIG. 9A, the operation unit is configured as an apparatus having: a disconnection switch prepared for each station line; a switch prepared for each room; a state display switch; and a settlement switch.

The operation to the operation unit is explained along the operation example. The administrator at the reception, when receiving the usage request of the Internet from the user of, for example, Room 101 through an internal call, turns on the state display switch, and a usage state screen as shown in FIG. 9B is displayed on the display unit. The usage state screen continues to be displayed on the display unit, while the state display switch is on.

The administrator refers to the usage state displayed on the display unit and judges whether or not there is a non-used station line. However, if the ISP specification is received from the user, the administrator judges whether or not the station line corresponding to the specified ISP is used.

If a station line (for example, a station line 1) satisfying the request of the user is not used, the administrator turns on a switch (a switch of “No.101”) corresponding to the room number of the user and turns on a disconnection switch of the station line 1.

Then, a connection instruction indicating the connection between the extension line of Room 101 and the station line 1 is given from the operation panel 20 to the control operation unit 18A, and the selector switch 17 connects the extension line of Room 101 and the station line 1. After that, on the usage state screen, the content (“Station Line 1: Under Usage (Room 101)”) indicating the connection between the station line 1 and the extension line of Room 101 is displayed.

After that, the administrator, when receiving the end of the Internet usage through the internal call from the user of Room 101, turns off the disconnection switch of the station line 1. Then, the disconnection request for the connection is given to the control operation unit 18A, and the control operation unit 18A controls the selector switch 17 and disconnects the connection between the extension line of Room 101 and the station line 1.

Then, the usage state of the station line 1 on the usage state screen is changed to “Non-Usage”. Also, the screen indicating the connection time and fee, which are generated by the time monitoring/charging unit 18D of the transmission control apparatus 10, is displayed on the display unit (refer to FIG. 9C). Incidentally, the screen indicating the connection time and fee is displayed on the display unit. This screen is used in the settlement at the reception by the user.

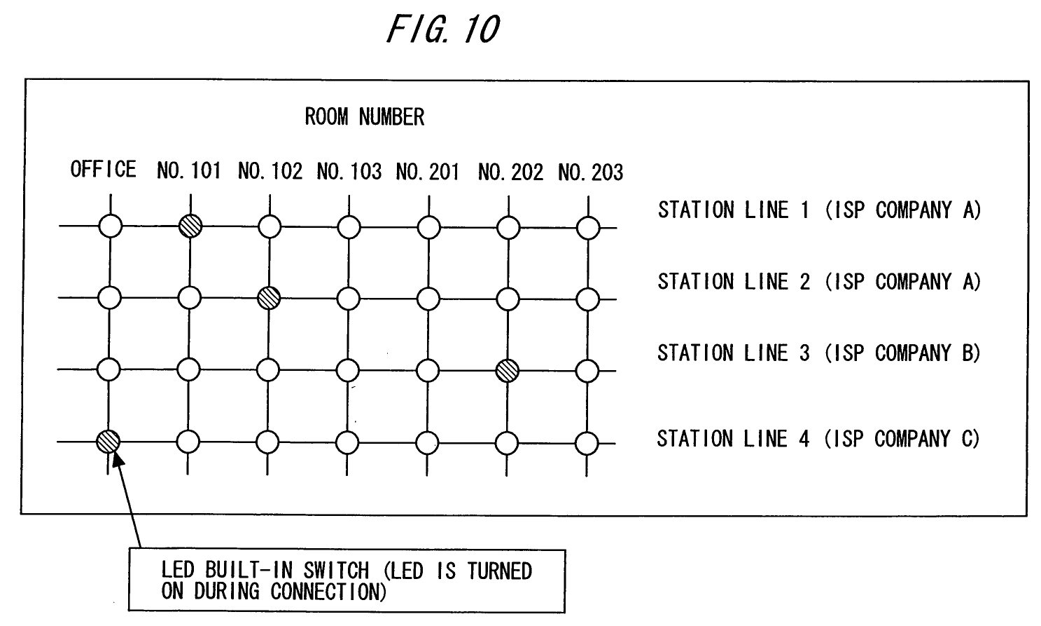

Also, a simple configuration as shown in FIG. 10 can be applied to the operation panel 20. In the example shown in FIG. 10, an operation unit and a display unit (a usage state display screen) are integrally configured. That is, an LED built-in switch (connecting/disconnecting switch) of a push button type is arranged at an intersection of a line representing the extension line of each room and a line representing each station line.

Each connecting/disconnecting switch is configured so as to output the connection request between the extension line and station line which intersect on the connecting/disconnecting switch to the control operation unit 18A when it is turned on, and output the disconnection request of the connection between the extension line and station line which intersect on the connecting/disconnecting switch to the control operation unit 18A when it is turned off.

Moreover, each connecting/disconnecting switch is configured so as to turn on the built-in LED at the on state, and the connecting/disconnecting switch which is turned on indicates the usage state of the selector switch 17. Thus, the state where all of the switches on the lines indicating all of the station lines (station lines 1 to 4) are respectively turned on (the state shown in FIG. 10) indicates that the selector switch 17 is in the unusable state. On the other hand, a case where any of the switches on the line representing a certain station line is not turned on indicates that the station line is not used.

If the operation panel 20 as shown in FIG. 10 is applied, the usage state screen as shown in FIG. 9B is not required.

[Effect]

According to the present invention, without any additional functions or and changes of the existing device (the telephone extension line system including PBX) or any development of a new exchange, using the ADSL modem, the splitter, and the transmission control apparatus according to the present invention can establish at low cost the necessary number of the usage environments of the Internet (with the number of extension lines which PBX can possibly accommodate as an upper limit).

Also, the introduction of the device required to establish the usage environment of the Internet is easy, thereby enabling the suppression in the cost with the viewpoint of the wiring work. In particular, it is possible to apply to the remote location where the extension line work is difficult, the place where a new work of LAN is difficult because of an old building facility, and the like.

In establishing the usage environment, the wiring work for connecting the existing device (PBX), the transmission control apparatus, and the like, and the work for isolating the speech signal and the data signal in the place where the extension line is wired (a room in a hotel and the like) are required. However, they are not the large-scale work, and the connecting work is easy.

The present invention can be applied to the business bodies, for example, such as a hotel and a company, which use the telephone extension line system.

[Others]

The disclosures of international application PCT/JP2003/002667 filed on Mar. 6, 2003 including the specification, drawings and abstract are incorporated herein by reference.

1. A data signal transmission control apparatus, comprising:
a connection unit for connecting any one of a plurality of first lines and any one of at least one second line that are accommodated in a switching unit between the first lines and the second lines for transmitting a speech signal;
a control unit for controlling the connection operation of the connection unit; and
an isolation/insertion unit for isolating a data signal, flowing on one of the first and second lines connected by the connection unit, from the one line and inserting the data signal isolated from the one line onto the other line.

2. The data signal transmission control apparatus according to claim 1, wherein the control unit receives, from a speech terminal connected to a certain first line, a request signal for connecting the certain first line and a second line, and controls the connection unit so that the certain first line and the second line are connected in accordance with the request signal.

3. The data signal transmission control apparatus according to claim 2, wherein the control unit outputs a guidance signal including guidance for connecting the certain first line and the second line from the speech terminal to the speech terminal.

4. The data signal transmission control apparatus according to claim 3, wherein the control unit, when the connection unit cannot connect the certain first line and the second line in accordance with the request signal from the speech terminal, receives from the speech terminal a request signal indicative of waiting for the connection unit to become usable for being capable of connecting the certain first line and the second line, and when the connection unit becomes usable, the connection unit notifies of the speech terminal of the usable state thereof.

5. The data signal transmission control apparatus according to claim 2, wherein the request signal is given to the control unit of the transmission control apparatus through a connection path that is formed between the transmission control apparatus and the speech terminal via the switching unit and includes the certain first line.

6. The data signal transmission control apparatus according to claim 2, wherein the control unit controls the connection unit so that this certain first line and the second line are connected or disconnected, in accordance with a connection or disconnection instruction between the certain first line and the second line that is manually inputted from an operation unit.

7. The data signal transmission control apparatus according to claim 1, wherein the control unit monitors a communication time resulting from the connection between the first line and the second line that are connected by the connection unit, and charges by an amount of the connection time.

8. The data signal transmission control apparatus according to claim 1, wherein the control unit controls the connection unit to disconnect the connection between the first line and the second line when the connection time between the first line and the second line reaches a predetermined communicable time.

9. The data signal transmission control apparatus according to claim 1, wherein
the control unit sends a signal including guidance related to the connection between the certain first line and the second line to the speech terminal, through the connection path between the transmission control apparatus and the speech terminal accommodating the certain first line via the switching unit generated by a call of the speech terminal connected to the certain first line, and also receives the request signal related to the connection between the certain first line and the second line that is outputted from the speech terminal in response to the guidance, through the connection path.
